(19) United States
(12) Patent Application Publication
(10) Pub. No.: US 2021/0333466 A1
(43) Pub. Date: Oct. 28, 2021

(54) BACKLIGHT MODULE, DISPLAY DEVICE, AND MANUFACTURING METHOD OF BACKLIGHT MODULE

(71) Applicant: Wuhan China Star Optoelectronics Technology Co., Ltd., Wuhan (CN)

(72) Inventors: Wei ZHOU, Wuhan (CN); Wei ZHANG, Wuhan (CN)

(73) Assignee: Wuhan China Star Optoelectronics Technology Co., Ltd., Wuhan (CN)

(21) Appl. No.: 16/625,735

(22) PCT Filed: Oct. 25, 2019
(86) PCT No.: PCT/CN2019/113180

§ 371 Date: Dec. 22, 2019

(30) Foreign Application Priority Data
Jul. 23, 2019 (CN) 201910665022.2

(51) Int. Cl. F21V 8/00; H04N 5/225; G09F 9/30

(52) U.S. Cl. CPC G02B 6/0055; G02B 6/0053; G09F 9/30; G02B 6/0065; H04N 5/2252; G02B 6/0051

(57) ABSTRACT

A backlight module, display device, and a manufacturing method of a backlight module are provided. The backlight module includes a back plate, a reflective sheet, a light guide plate, an optical diaphragm set, and a sleeve. A perforation is disposed on the backlight module, and the perforation sequentially penetrates through the back plate, the reflective sheet, the light guide plate, and the optical diaphragm set. The sleeve is sleeved in the perforation. The sleeve is hollow, and a sleeve side wall encircles to form a backlight hole. The display device includes the backlight module, a display panel, and a light shielding adhesive between them. The manufacturing method of a backlight module includes steps: providing a back plate, manufacturing a reflective sheet, manufacturing a light guide plate, manufacturing an optical diaphragm set to form a perforation, and manufacturing a sleeve sleeved in the perforation.

### FIELD OF INVENTION

The present disclosure relates to field of display, and particularly relates to a backlight module, a display device, and a manufacturing method of a backlight module.

### BACKGROUND OF INVENTION

With development of display technology, camera under panel (CUP) technology has been widely accepted upon its launch, and based on development of full screens of mobile phones, outer diameters of cameras on the screens have become increasingly smaller.

Current display devices include a backlight module and a display panel which are disposed oppositely. A conventional structure of the backlight module includes two types: a pure iron frame, which is from a panel being pressed and bent, and a plastic-iron integrated structure. A diameter of a designed backlight hole for disposing a camera in the backlight module is required to be synchronously reduced.

If the backlight module is a structure from a panel being pressed and bent, the backlight hole is formed by pressing and bending the panel constituting the backlight module. When the backlight hole of the backlight module is less than 2.7 mm, because the backlight hole is formed from a pressing process, the pressing process limits a depth of the backlight hole to be manufactured to 0.7 mm at most. Because the depth of the pressed backlight hole is too shallow to meet requirements for stacking films, the diameter of the backlight hole of this structure should be greater than 2.7 mm; therefore, the backlight hole with a diameter of less than 2.7 mm cannot be provided.

If the backlight module is a plastic-iron structure, it is required to make a sealant and the panel to bond together to constitute an integrated backlight hole. At this time, the backlight module is required to connect to a display panel through a light shielding adhesive, and the light shielding adhesive is attached to the sealant with a certain width to ensure that it does not fall off. Therefore, when a width of the sealant is at a minimum value, the formed backlight hole ranges from 1.53 mm to 2.0 mm, and a maximal value of a diameter of the backlight hole of this structure is 2.0 mm, which cannot be manufactured to be larger. Limited by camera technology, a minimum diameter of a current camera is 2.0 mm, and only can be used on a backlight hole and a camera with a diameter equal to 2.0 mm. Hence, a ratio of manufactured finished products of the backlight module and the camera is low, while their cost is high.

When the backlight module is a plastic-iron structure, and a diameter of the backlight hole is less than 2.0 mm, at this time, no camera with a corresponding size can be matched. If it is able to use camera technology of prior art, the backlight module should be manufactured by adopting a back plate bending structure, and a range of a diameter of the backlight hole is larger than 2.7 mm. Especially, when the backlight hole diameter ranges from 2.0 mm to 2.7 mm, it is a blank field. General structures of current backlight modules with backlight holes cannot meet the requirements, so a new backlight module, a display device and a manufacturing method of a backlight module are needed to solve the problem.

### SUMMARY OF INVENTION

The purpose of the present disclosure is to provide a backlight module, a display device, and a manufacturing method of a backlight module, which solves the problem that a size of a diameter of a camera is limited, and realizes collocation of a backlight hole of the backlight module and a camera with a current size.

In order to solve the problem mentioned above, the present disclosure provides a backlight module, including a back plate, a reflective sheet, a light guide plate, an optical diaphragm set, and a sleeve. Specifically, the reflective sheet is disposed on the back plate. The light guide plate is disposed on the reflective sheet. The optical diaphragm set is disposed on the light guide plate. A perforation is disposed on the backlight module, and the perforation sequentially penetrates through the back plate, the reflective sheet, the light guide plate, and the optical diaphragm set. The sleeve is sleeved in the perforation, the sleeve is hollow, and a sleeve side wall encircles to form a backlight hole.

Further, the sleeve includes the sleeve side wall and a sleeve margin. Specifically, a length of the sleeve side wall is same as a depth of the perforation, the sleeve margin is perpendicular to the sleeve side wall, and the sleeve margin encircles the sleeve side wall in a ring shape.

Further, the backlight module further includes a double-sided tape. The double-sided tape is attached between the sleeve margin of the sleeve and the back plate.

Further, a shape and a dimension of the sleeve side wall adapt to a shape and a dimension of the perforation.

Further, material of the sleeve includes one of iron, aluminum, stainless steel, aluminum alloy, hard plastic, or injection molding colloid.

Further, the optical diaphragm set includes a diffusion sheet, a bottom brightness enhancement sheet, and an upper brightness enhancement sheet. Specifically, the diffusion sheet is disposed on the light guide plate, the bottom brightness enhancement sheet is disposed on the diffusion sheet, and the upper brightness enhancement sheet is disposed on the bottom brightness enhancement sheet.

The present disclosure further provides a display device, including the backlight module mentioned above, a display panel, and a light shielding adhesive between them.

The present disclosure further provides a manufacturing method of a backlight module, including:

Providing a back plate.

Manufacturing a reflective sheet on the back plate.

Manufacturing a light guide plate on the reflective sheet.

Manufacturing an optical diaphragm set on the light guide plate. Further, a perforation is opened on the backlight module, and the perforation sequentially penetrates through the back plate, the reflective sheet, the light guide plate, and the optical diaphragm set.

Manufacturing a sleeve, making the sleeve be sleeved in the perforation, the sleeve is hollow, and a sleeve side wall encircles to form a backlight hole.

Further, a method of manufacturing the sleeve includes a pressing method, or an injection molding method.

Further, a step of sleeving the sleeve in the perforation includes:

Attaching a double-sided tape on a side of the back plate away from the reflective sheet.

Sleeving the sleeve in the perforation and attaching the sleeve on the back plate by the double-sided tape.

The beneficial effect of the present disclosure is to provide a backlight module, a display device, and a manufacturing method of a backlight module. By using a sleeve sleeved in a perforation of the backlight module to form a backlight hole, difficulty in design and manufacturing is greatly reduced, thereby effectively saving cost, which solves the problem that an aperture size of the backlight module is limited by processes during bending or injection molding, and the backlight hole of a required specification can be obtained, which is not limited by the aperture size. Especially, when a diameter of the backlight hole ranges from 2.0 mm to 2.7 mm, a current manufactured camera can be placed in, and it is not limited by a size of the camera, thereby solving the problem of the backlight module collocating with a camera with a current size.

### DETAILED DESCRIPTION OF PREFERRED EMBODIMENTS

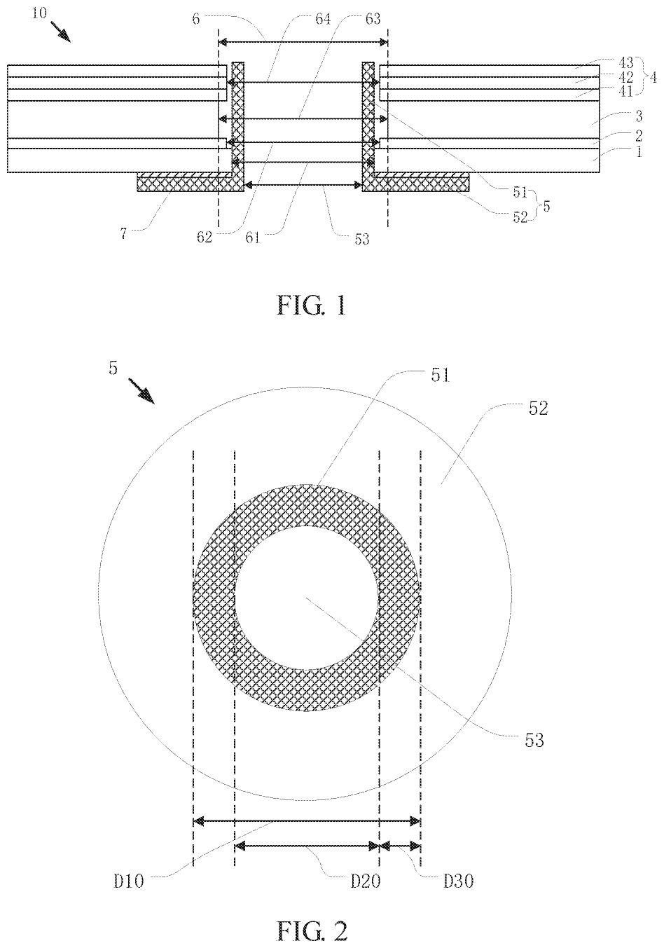

FIG. 1 is a structural schematic diagram of a backlight module in an embodiment of the present disclosure.

FIG. 2 is a top view of a sleeve in an embodiment of the present disclosure.

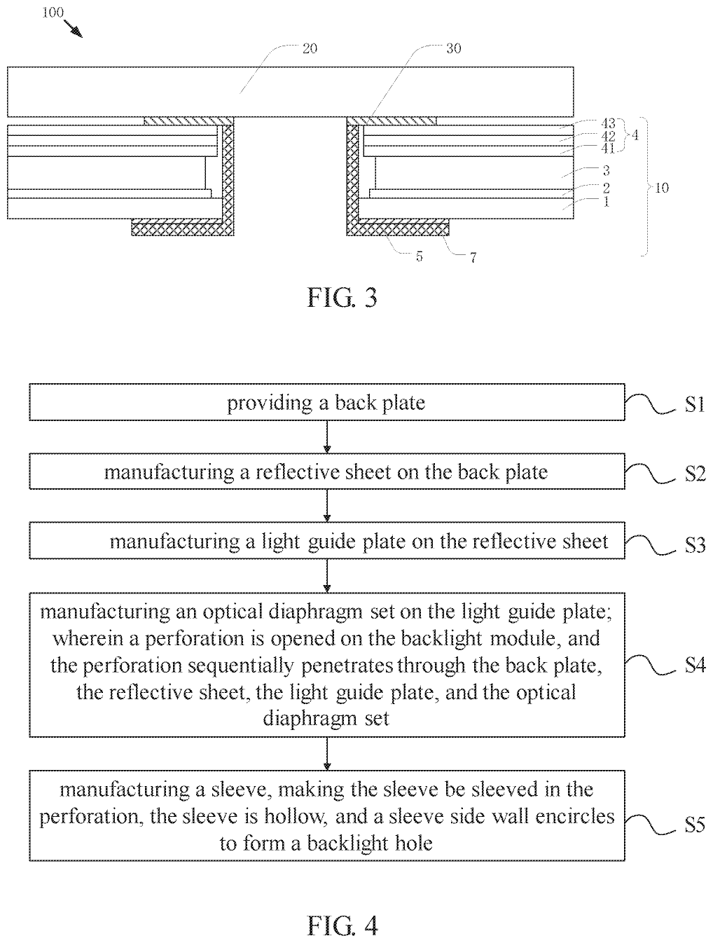

FIG. 3 is a structural schematic diagram of a display device in an embodiment of the present disclosure.

FIG. 4 is a flowchart of a manufacturing method of a backlight module in an embodiment of the present disclosure.

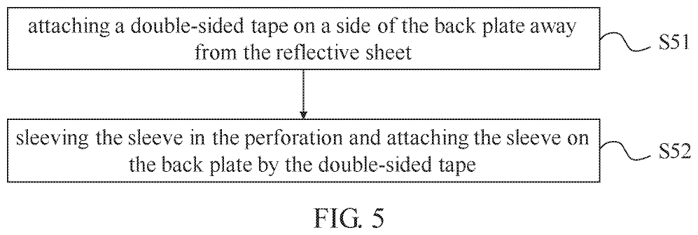

FIG. 5 is a flowchart of making the sleeve be sleeved in the perforation of FIG. 4.

### DETAILED DESCRIPTION OF PREFERRED EMBODIMENTS

The descriptions of embodiments below refer to accompanying drawings in order to illustrate certain embodiments which the present disclosure can implement. The directional terms of which the present disclosure mentions, for example, “top”, “bottom”, “upper”, “lower”, “front”, “rear”, “left”, “right”, “inside”, “outside”, “side,” etc., only refer to directions of the accompanying figures. Therefore, the used directional terms are for illustrating and understanding the present disclosure, but not for limiting the present disclosure. In the figures, units with similar structures are indicated by the same reference numerals.

In the drawings, the thicknesses of layers and regions are exaggerated for clarity. For example, for ease of description, the dimensions and thickness of each component shown in the drawings are arbitrarily shown, and the present disclosure does not limit the dimensions and thickness of each component.

Please refer to FIG. 1, an embodiment of the present disclosure provides a backlight module 10, including a back plate 1, a reflective sheet 2, a light guide plate 3, an optical diaphragm set 4, and a sleeve 5.

Specifically, a material of the back plate 1 includes one of iron, aluminum, stainless steel, aluminum alloy, hard plastic, or injection molding colloid, and iron is preferred. The reflective sheet 2 is disposed on the back plate 1, and the back plate 1 serves a supporting function. The reflective sheet 2 is used for reflecting light, and has good reflection performance. The light guide plate 3 is disposed on the reflective sheet 2. The light guide plate 3 uses an optical grade acrylic plate to absorb light from a light source and keep the light on a surface of the optical grade acrylic plate. When the light hits each grid dots, the reflected light will diffuse to various angles, and breaks a reflection condition, then emits from a front side of the light guide plate. By the various grid dots with different densities and sizes, the light guide plate 3 can be made to emit light uniformly. The optical diaphragm set 4 is disposed on the light guide plate 3, and the optical diaphragm set 4 is used for enhancing brightness and uniformity of the light source. Furthermore, a perforation 6 is opened on the backlight module 10, and the perforation sequentially penetrates through the back plate 1 with an iron frame, the reflective sheet 2, the light guide plate 3, and the optical diaphragm set 4. The perforation 6 forms a first via 61 on the back plate 1, forms a second via 62 on the reflective sheet 2, forms a third via 63 on the light guide plate 3, and forms a fourth via 64 on the optical diaphragm set 4. The first via 61, the second via 62, the third via 63, and the fourth via 64 jointly form the perforation 6. The sleeve 5 is sleeved in the perforation 6, and the sleeve 5 is hollow. A sleeve side wall, which is an inner wall of the sleeve 5, encircles to form a backlight hole 53.

Please refer to FIG. 1 and FIG. 2, a diameter D1 of the first via 61, a diameter D2 of the second via 62, a diameter D3 of the third via 63, and a diameter D4 of the fourth via 64 are greater than or equal to a diameter D10 of the perforation 6, more specifically, D3≥D2≥D4≥D1≥D10. A sleeve side wall 51 encircles to form the backlight hole 53 of the backlight module 10, and the diameter D10 of the perforation 6 is greater than or equal to a diameter D20 of the backlight hole 53 plus thickness values D30 of two side walls of the sleeve side wall 51, that is, D10≥D20+2*D30. A range of the diameter D20 of the backlight hole 53 includes 2.0 mm to 2.7 mm.

This embodiment greatly reduces difficulty in design and manufacturing of the backlight module 10 by using the sleeve sleeved in the perforation 6, thereby effectively saving cost, and solves the problem that an aperture size of the backlight hole 53 is limited by processes, and the backlight hole 53 of a required specification can be obtained, which is not limited by the aperture size. Especially, when the diameter of the backlight hole 53 ranges from 2.0 mm to 2.7 mm, a current manufactured camera can be placed in, and it is not limited by a size of the camera, thereby solving the problem of the backlight hole 53 of the backlight module 10 collocating with a camera with a current size.

Please refer to FIG. 1 and FIG. 2, in this embodiment, the sleeve 5 includes the sleeve side wall 51 and a sleeve margin 52. The sleeve side wall 51 is formed by bending the sleeve margin 52 at a right angle in a radial direction. Specifically, the sleeve side wall 51 encircles to form the backlight hole 53 of the backlight module 10, and a length of the sleeve side wall 51 is same as a depth of the perforation 6. The sleeve margin 52 is perpendicular to the sleeve side wall 51, and the sleeve margin 52 encircles the sleeve side wall 51 in a ring shape.

Please refer to FIG. 1 and FIG. 2, in this embodiment, the backlight module 10 further includes a double-sided tape 7. The double-sided tape 7 is attached between the sleeve margin 52 of the sleeve 5 and the back plate 1, which is used for bonding the sleeve 5 on the back plate 1 firmly. Specifically, a side of the sleeve side wall 51 on the back plate 1 away from the reflective sheet 2 is sleeved in the perforation 6, and the sleeve margin 52 is attached to the back plate 1 by the double-sided tape 7. A shape and a dimension of the double-sided tape 7 adapt to a shape and a dimension of the sleeve margin 52, that is, the double-sided tape 7 is in a ring shape. Adopting a method of using the double-sided tape for attaching greatly reduces difficulty of manufacturing the backlight module 10, thereby saving cost effectively. Moreover, it is only necessary to control a qualified rate of the sleeve 5 and the back plate 1 to ensure a qualified rate of the backlight module 10, making the method very practical.

In this embodiment, a shape and a dimension of the sleeve 5 adapt to a shape and a dimension of the perforation 6. That is, cross sections of the sleeve 5 and the perforation 6 are one of a circular shape, a rectangular shape, or a polygonal shape. In this embodiment, the cross sections of the sleeve 5 and the perforation 6 are preferred to be a circular shape, and at this time, it should be understood that centers of circles of the first via 61, the second via 62, the third via 63, and the fourth via 64 are on a same line.

In this embodiment, a material of the sleeve 5 includes one of iron, aluminum, stainless steel, aluminum alloy, hard plastic, or injection molding colloid. It is worth mentioning that materials listed above are the preferred materials of the sleeve 5, the material of the sleeve 5 is only required to form an integrated structure, and all of them belong to the protection scope of the present disclosure.

Please refer to FIG. 1, the optical diaphragm set 4 includes a diffusion sheet 41, a bottom brightness enhancement sheet 42, and an upper brightness enhancement sheet 43. Specifically, the diffusion sheet 41 is disposed on the light guide plate 3, the bottom brightness enhancement sheet 42 is disposed on the diffusion sheet 41, and the upper brightness enhancement sheet 43 is disposed on the bottom brightness enhancement sheet 42. The optical diaphragm set 4 is used for enhancing brightness and uniformity of the light source. The diffusion sheet 41 is used for enhancing brightness of the light source. The bottom brightness enhancement sheet 42 diffuses light for providing a uniform planar light source. The upper brightness enhancement sheet 43 can also enhance brightness of the light source. Light emitting effect of the backlight module 10 directly affects its visual effect.

Please refer to FIG. 3, the present disclosure further provides a display device 100, including the backlight module 10 mentioned above, a display panel 20, and light shielding adhesive 30 between them. The light shielding adhesive 30 is used for bonding the backlight module 10 and the display panel 20.

Specifically, part of a bottom surface of the light shielding adhesive 30 is attached on a top end of the sleeve side wall 51, another part is attached on an upper surface of the upper brightness enhancement sheet 43, and an upper surface of the light shielding adhesive 30 is attached to a bottom surface of the display panel 20; thereby, the light shielding adhesive 30 bonds and combines the backlight module 10 and the display panel. The light shielding adhesive 30 serves a function of connecting the backlight module 10 and the display panel 20, and can prevent light leakage of the backlight module 10 on a position of the perforation 6. Therefore, a shape and a dimension of the light shielding adhesive 30 adapt to a shape and a dimension of the perforation 6, that is the light shielding adhesive 30 is in a ring shape and encircles the perforation 6. That is, the sleeve 5 is hollow, the sleeve side wall 51, which is the inner wall of the sleeve 5, encircles to form the backlight hole 53, and there is no the light shielding adhesive 30 disposed on a position corresponding to the backlight hole 53.

The display device 100 in this embodiment can be any products or components having display functions, such as mobile phones, tablet PCs, televisions, display devices, laptops, digital photo frames, global positioning systems, and the like.

This embodiment provides a working principle of the display device 100, which is same as a working principle of embodiments of the backlight module 10, and a specific structural relationship and the working principle can refer to the embodiments of the backlight module 10, and details will not be mentioned herein.

Please refer to FIG. 4, the present disclosure further provides a manufacturing method of a backlight module 10, which includes the following steps S1 to S5:

S1, providing a back plate 1, a material of the back plate 1 includes one of iron, aluminum, stainless steel, aluminum alloy, hard plastic, or injection molding colloid, and pressing a first via 61 on the back plate 1.

S2, manufacturing a reflective sheet 2 on the back plate 1. A second via 62 disposed opposite to the first via 61 is disposed on the reflective sheet 2.

S3, manufacturing a light guide plate 3 on the reflective sheet 2. A third via 63 disposed opposite to the second via 62 is disposed on the light guide plate 3.

S4, manufacturing an optical diaphragm set 4 on the light guide plate 3. A fourth via 64 disposed opposite to the third via 63 is disposed on the optical diaphragm set 4. Furthermore, the first via 61, the second via 62, the third via 63, and the fourth via 64 constitute a perforation 6 together. It will be understood, that the perforation 6 is opened on the backlight module 10, and the perforation 6 sequentially penetrates through the back plate 1 with an iron frame, the reflective sheet 2, the light guide plate 3, and the optical diaphragm set 4. That is, the perforation 6 forms the first via 61 on the back plate 1, forms the second via 62 on the reflective sheet 2, forms the third via 63 on the light guide plate 3, and forms the fourth via 64 on the optical diaphragm set 4.

S5, manufacturing a sleeve 5, making the sleeve 5 be sleeved in the perforation 6. The sleeve 5 is hollow, and a sleeve side wall encircles to form a backlight hole 53.

Furthermore, a shape and a dimension of the sleeve 5 adapt to a shape and a dimension of the perforation 6. That is, cross sections of the sleeve 5 and the perforation 6 are one of a circular shape, a rectangular shape, or a polygonal shape. Preferably, both the sleeve 5 and the perforation 6 are circles, which are circular holes. At this time, it will be understood that centers of circles of the first via 61, the second via 62, the third via 63, and the fourth via 64 are on a same line.

Please refer to FIG. 1 and FIG. 2, a diameter D1 of the first via 61, a diameter D2 of the second via 62, a diameter D3 of the third via 63, and a diameter D4 of the fourth via 64 are greater than or equal to a diameter D10 of the perforation 6, more specifically, D3≥D2≥D4≥D1≥D10. A sleeve side wall 51 encircles to form the backlight hole 53 of the backlight module 10, and the diameter D10 of the perforation 6 is greater than or equal to the diameter D20 of the backlight hole 53 plus thickness values D30 of two side walls of the sleeve side wall 51, that is, D10≥D20+2*D30. A range of the diameter D20 of the backlight hole 53 includes 2.0 mm to 2.7 mm.

In this embodiment, a method of manufacturing the sleeve includes a pressing method, or an injection molding method, and a material of the sleeve 5 includes one of iron, aluminum, stainless steel, aluminum alloy, hard plastic, or injection molding colloid.

Please refer to FIG. 1 and FIG. 2, the sleeve 5 includes the sleeve side wall 51 and a sleeve margin 52, and the sleeve side wall 51 is formed by bending the sleeve margin 52 at a right angle in a radial direction. A length of the sleeve side wall 51 is same as a depth of the perforation 6. The sleeve margin 52 is perpendicular to the sleeve side wall 51, and the sleeve margin 52 encircles the sleeve side wall 51 in a ring shape.

Please refer to 5, in this embodiment, a step of sleeving the sleeve 5 in the perforation 6 specifically includes:

S51, attaching a double-sided tape 7 on a side of the back plate 1 away from the reflective sheet 2.

S52, sleeving the sleeve 5 in the perforation 6 and attaching the sleeve 6 on the back plate 1 by the double-sided tape 7. In other words, a side of the sleeve side wall 51 of the sleeve 5 from the back plate 1 away from the reflective sheet 2 is sleeved in the perforation 6, the sleeve margin 52 is attached to the back plate 1 by the double-sided tape 7.

Adopting a method of using the double-sided tape 7 for attaching greatly reduces difficulty in design and manufacturing, thereby saving cost effectively. Moreover, it is only necessary to control a qualified rate of the sleeve 5 and the back plate 1 to ensure a qualified rate of the backlight module 10, making the method very practical.

By pressing a first via 61 on the back plate 1, wherein the first via 61 is preferred to be a circular shape, that is, a circular hole; then, by pressing one of the sleeve 5, wherein an internal diameter of the sleeve 5 is equal to the required diameter of the backlight hole 53, and the pressed sleeve 5 is sleeved in the perforation 6 where the first via 61 is located to form the backlight hole 53; and by using the double-sided tape 7 for attaching, the manufacturing method of the backlight module 10 provided by the present disclosure can not only solve the problem of an aperture size limited by processes during bending or injection molding, but also obtain the backlight hole 53 of a required specification, which is not limited by the aperture size. A range of the diameter of the backlight hole 53 which enables manufacturing includes 2.0 mm to 2.7 mm, and a current manufactured camera can be placed in, and it is not limited by a size of the camera, thereby solving the problem of the backlight hole 53 of the backlight module 10 collocating with a camera with a current size.

The beneficial effect of the present disclosure is to provide a backlight module, a display device, and a manufacturing method of a backlight module. By using a sleeve sleeved in a perforation of the backlight module to form a backlight hole, difficulty in design and manufacturing is greatly reduced, thereby effectively saving cost, which solves the problem of an aperture size of the backlight module is limited by processes during bending or injection molding, and the backlight hole of a required specification can be obtained, which is not limited by the aperture size. A range of the diameter of the backlight hole which enables manufacturing includes 2.0 mm to 2.7 mm, and a current manufactured camera can be placed in, and it is not limited by a size of the camera, thereby solving the problem of the backlight module collocating with a camera with a current size.

The above-mentioned are preferred embodiments of the present disclosure. It should be noted that those skilled in the art, without departing from the technical theory of the present disclosure, can further make many changes and modifications, and the changes and the modifications should be considered as the scope of protection of the present disclosure.

What is claimed is:

1. A backlight module, comprising:
a back plate;
a reflective sheet disposed on the back plate;
a light guide plate disposed on the reflective sheet; and
an optical diaphragm set disposed on the light guide plate;
wherein a perforation is disposed on the backlight module, the perforation sequentially penetrates through the back plate, the reflective sheet, the light guide plate, and the optical diaphragm set; and
a sleeve is sleeved in the perforation, the sleeve is hollow, and a sleeve side wall encircles to form a backlight hole.

2. The backlight module as claimed in claim 1, wherein the sleeve comprises:
the sleeve side wall, and a length of the sleeve side wall being same as a depth of the perforation;
a sleeve margin perpendicular to the sleeve side wall, and the sleeve margin encircling the sleeve side wall in a ring shape.

3. The backlight module as claimed in claim 1, further comprising a double-sided tape, the double-sided tape is attached between a sleeve margin of the sleeve and the back plate.

4. The backlight module as claimed in claim 1, wherein a shape and a dimension of the sleeve side wall adapt to a shape and a dimension of the perforation.

5. The backlight module as claimed in claim 1, wherein a material of the sleeve comprises one of iron, aluminum, stainless steel, aluminum alloy, hard plastic, or injection molding colloid.

6. The backlight module as claimed in claim 1, wherein the optical diaphragm set comprises:
a diffusion sheet disposed on the light guide plate;
a bottom brightness enhancement sheet disposed on the diffusion sheet; and
an upper brightness enhancement sheet disposed on the bottom brightness enhancement sheet.

7. A display device, comprising the backlight module as claimed in claim 1, a display panel, and a light shielding adhesive between the backlight module and the display panel.

8. A manufacturing method of a backlight module, comprising steps:
providing a back plate;
manufacturing a reflective sheet on the back plate;
manufacturing a light guide plate on the reflective sheet;
manufacturing an optical diaphragm set on the light guide plate;
wherein a perforation is opened on the backlight module, and the perforation sequentially penetrates through the back plate, the reflective sheet, the light guide plate, and the optical diaphragm set; and
manufacturing a sleeve, making the sleeve be sleeved in the perforation, the sleeve is hollow, and a sleeve side wall encircles to form a backlight hole.

9. The manufacturing method of the backlight module as claimed in claim 8, wherein a method of manufacturing the sleeve comprises a pressing method, or an injection molding method.

10. The manufacturing method of the backlight module as claimed in claim 8, wherein a step of sleeving the sleeve in the perforation comprises:
attaching a double-sided tape on a side of the back plate away from the reflective sheet; and
sleeving the sleeve in the perforation and attaching the sleeve on the back plate by the double-sided tape.
